(19) United States
(12) Patent Application Publication
(10) Pub. No.: US 2025/0334333 A1
(43) Pub. Date: Oct. 30, 2025

(54) SYSTEMS, DEVICES, AND METHODS FOR PURIFYING ATMOSPHERE IN A VACUUM FURNACE

(71) Applicant: Desktop Metal, Inc., Burlington, MA (US)

(72) Inventors: Nathan Woodard, Medford, MA (US); Shashank Holenarasipura Raghu, Burlington, MA (US); Michael Andrew Gibson, Philadelphia, PA (US)

(73) Assignee: Desktop Metal, Inc., Burlington, MA (US)

(21) Appl. No.: 18/977,147

(22) Filed: Dec. 11, 2024

Related U.S. Application Data
(63) Continuation of application No. 17/460,028, filed on Aug. 27, 2021, now abandoned.
(60) Provisional application No. 63/071,822, filed on Aug. 28, 2020.

(51) Int. Cl. F27B 5/04; F27B 5/16; F27D 7/06; F27D 17/20

(52) U.S. Cl. CPC F27B 5/04; F27B 5/16; F27D 7/06; F27D 17/20; F27D 2007/066

(57) ABSTRACT

The present disclosure includes a furnace for heating and/or sintering one or more three-dimensional printed metal parts. The furnace includes a furnace chamber, insulation within the furnace chamber, a retort within the furnace chamber, and one or more getters containing getter material. The retort is configured to receive the one or more three-dimensional printed metal parts.

### BRIEF REFERENCE TO RELATED APPLICATION

This application claims priority to U.S. Provisional Patent Application No. 63/071,822 filed Aug. 28, 2020, the contents of which are herein incorporated by reference in their entirety.

### TECHNICAL FIELD

Various aspects of the present disclosure relate generally to systems, devices, and methods for purifying an atmosphere in a vacuum furnace. Specifically, various aspects of the present disclosure relate generally to systems, devices, and methods for purifying an atmosphere in a vacuum sintering furnace for heating and/or sintering a three-dimensional printed metal part.

### BACKGROUND OF THE DISCLOSURE

Furnaces for sintering three-dimensional printed parts may include a low density fibrous and/or porous ceramic insulation pack, which may adsorb significant amounts of water when exposed to the ambient atmosphere. Similar fibrous and/or porous insulation can be constructed of graphite which tends to absorb less water that ceramic but nevertheless absorbs some. When processing parts, this water desorbs and enters the hot zone at high temperatures, where the water may react with a graphite retort and form CO and/or CO₂. Organic molecules that may result from pyrolysis of the polymer from the printed parts may also condense and/or accumulate in the insulation pack. These organic molecules can become volatile when the insulation pack is heated on a subsequent treatment run and may provide a source of reactive species. These reactive species may contaminate an inert atmosphere in the hot zone, which may be necessary for proper sintering performance. For example, these reactive species may react with the parts and alter the chemical composition of the part material.

The systems and methods of the current disclosure may address one or more of the deficiencies described above or may address other aspects of the prior art.

### SUMMARY OF THE DISCLOSURE

Examples of the present disclosure relate to, among other things, systems, devices, and methods for purifying an atmosphere in a vacuum furnace, for example, for purifying an atmosphere in a vacuum sintering furnace for heating and/or sintering a three-dimensional printed metal part. Each of the examples disclosed herein may include one or more of the features described in connection with any of the other disclosed examples.

The present disclosure includes a furnace for heating and/or sintering one or more three-dimensional printed metal parts. The furnace may include a furnace chamber, insulation within the furnace chamber, a retort within the furnace chamber, and one or more getters containing getter material. The retort may be configured to receive the one or more three-dimensional printed metal parts.

According to some aspects, the retort may be at least partially sealed. The one or more getters may be positioned outside of the retort. The one or more getters may be positioned inside of the retort. The one or more getters may be positioned on or within the insulation. The getter material may be zirconium or a zirconium alloy. The zirconium or the zirconium alloy may be a pulverized sponge or sponge grit.

Both the foregoing general description and the following detailed description are exemplary and explanatory only and are not restrictive of the features, as claimed. As used herein, the terms “comprises,” “comprising,” “including,” “having,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Additionally, the term “exemplary” is used herein in the sense of “example,” rather than “ideal.” References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth. The terms “object,” “part,” and “component,” as used herein, are intended to encompass any object fabricated through the additive manufacturing techniques described herein.

It should be noted that all numeric values disclosed or claimed herein (including all disclosed values, limits, and ranges) may have a variation of +/−10% (unless a different variation is specified) from the disclosed numeric value. In this disclosure, unless stated otherwise, relative terms, such as, for example, “about,” “substantially,” and “approximately” are used to indicate a possible variation of +/−10% in the stated value. Moreover, in the claims, values, limits, and/or ranges of various claimed elements and/or features means the stated value, limit, and/or range +/−10%.

### BRIEF DESCRIPTION OF THE DRAWINGS

The accompanying drawings, which are incorporated in and constitute a part of this specification, illustrate various exemplary embodiments, and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this disclosure.

FIG. 1 illustrates an exemplary retort, according to aspects of the present disclosure.

FIGS. 2A-E illustrate various states of an exemplary furnace system, according to aspects of the present disclosure.

FIG. 3 depicts contaminants in a furnace system.

FIG. 4 depicts the methods of contamination in a furnace system.

FIGS. 5A and 5B illustrate various details of the exemplary furnace system and getters.

FIG. 6 illustrates an embodiment retort assembly.

FIGS. 7A-B depict another embodiment retort assembly.

FIG. 8 depicts a retort top plate having a recess for receiving a getter.

FIGS. 9A-B illustrate various details of a retort assembly, according to aspects of the present disclosure.

### DETAILED DESCRIPTION

Embodiments of the present disclosure include systems, devices, and methods to facilitate or improve the efficacy or efficiency of additive manufacturing and heating and/or sintering parts made by additive manufacturing. Reference now will be made in detail to examples of the present disclosure described above and illustrated in the accompanying drawings. Wherever possible, the same reference numbers will be used throughout the drawings to refer to the same or like parts.

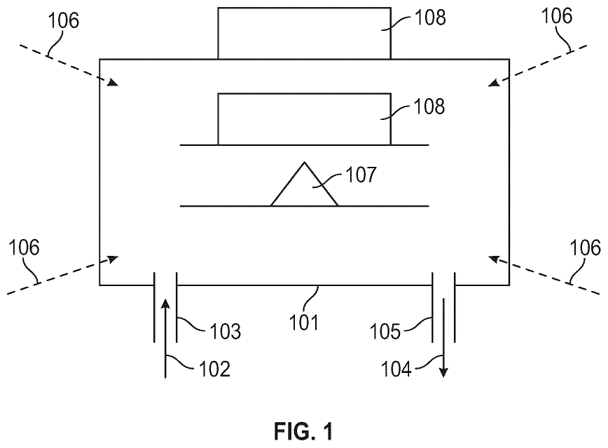

FIG. 1 illustrates an exemplary retort 101 that may be arranged in the hot zone of a furnace system for heating and/or sintering a printed part, according to an embodiment of the present disclosure, for example, a three-dimensional metal printed part. The furnace system includes a retort 101. The retort 101 may be a porous retort or may be a sealed retort with a hole or opening. In either aspect, the retort has what can be considered a conductance C with respect to the degree to which reactive species from outside the retort enters the retort. In FIG. 1, for modeling and understanding gas flow, it may be assumed for simplicity that a porous retort is roughly equivalent to a well-sealed retort with one or more holes or openings. Process gas 102 may flow into the retort through an inlet 103, and the effluent gas 104 may flow out of the retort through an outlet 105. Additionally, reactive species 106 may be present within the furnace system. For example, reactive species 106 can outgas from furnace walls, insulation, and/or parts. Reactive species may subsequently react with each other, with parts, and/or with insulation and retort materials and thus alter the chemical composition of themselves and/or of that with which they react. The reactive species may be transported from one place to another in the chamber with a given rate Q_{R}. The part 107 may absorb gas (such as a reactive species) in a manner that is analogous to a pump having pumping speed S_{P}. Moreover, the furnace system may include one or more getters 108 each capable of pumping by way of absorption with a pumping speed S_{G}. As shown in FIG. 1, the one or more getters 108 may be positioned outside of the retort and may pump Q_{R} with a pumping speed S₁, or the one or more getters 108 may be positioned inside of the retort and have a pumping speed S₂. If conductance C is very restrictive compared to S₁, then S₂ may pump Q_{R} at a proportionally lower rate as compared to S₁, even in cases where the inside getter arrangement is identical to the outside getter arrangement. For example, the conductance of the porous retort may be sufficiently low as to somewhat “choke” the effectiveness of S₂. In view of this, it may be advantageous in some embodiments to arrange the getter outside the retort.

The partial pressure of reactive species dependent on pumping speed of the getters (under molecular flow) can be expressed as:

$$P = \frac{{Q}_{R}}{{S}_{1}} .$$

$$\frac{1}{S} = \frac{1}{{S}_{2}} + \frac{1}{{S}_{P}} \to P ≅ ( \frac{1}{{S}_{2}} + \frac{1}{{S}_{P}} ) {Q}_{R}$$

With getters placed inside the retort, one can limit the partial pressure of reactive species, however, they are also competing with the pumping speed of the parts themselves.

By placing getters outside the retort, one can greatly reduce the amount of reactive species that are able to subsequently react inside the retort with the parts. With getters inside only, this is in parallel and may not yield the same degree of efficiency.

The furnace (for example the Studio System™ Furnace by Desktop Metal™ of Burlington, MA) may include various layers of insulation. For example, the furnace may use a-porous alumina-silica ceramic insulation pack. Embodiments in this disclosure are in reference to insulation that is fibrous and porous, whereas microporous is a term of art for a specialized subset of insulations that we do not employ. One skilled in the art will appreciate that at least some embodiments in this disclosure are applicable to systems that use microporous insulation. The internal structure of this fibrous and/or porous insulation material may be made with low mass density to suppress the conventional heat by solid conduction, resulting in pores and/or voids that also tend to suppress radiative heat transfer. In general, fibrous and/or porous morphology may tend to increase the surface area of the insulation. Reducing pore and/or void size increases surface area and may help to improve the material's insulating properties, thus providing a larger surface area for adsorption of reactive species.

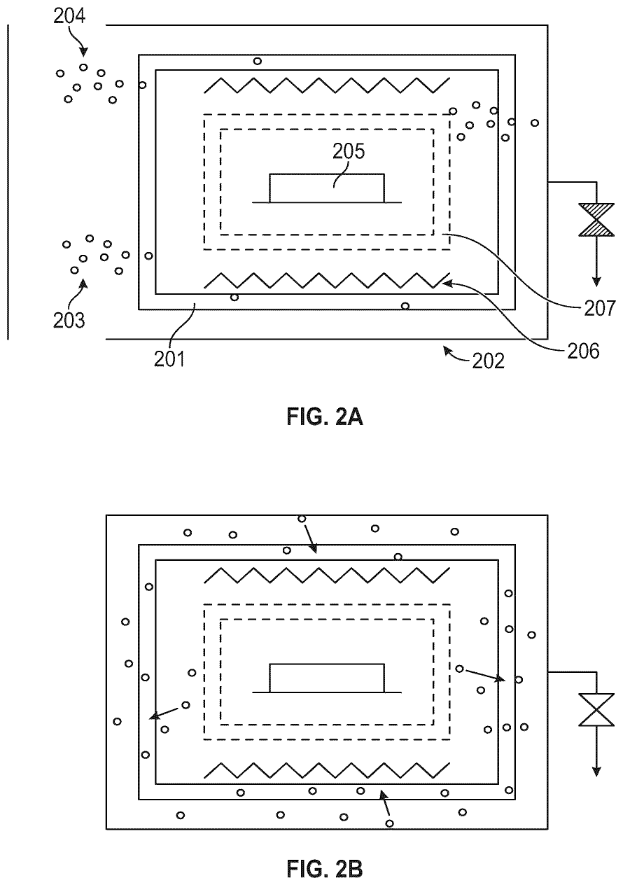

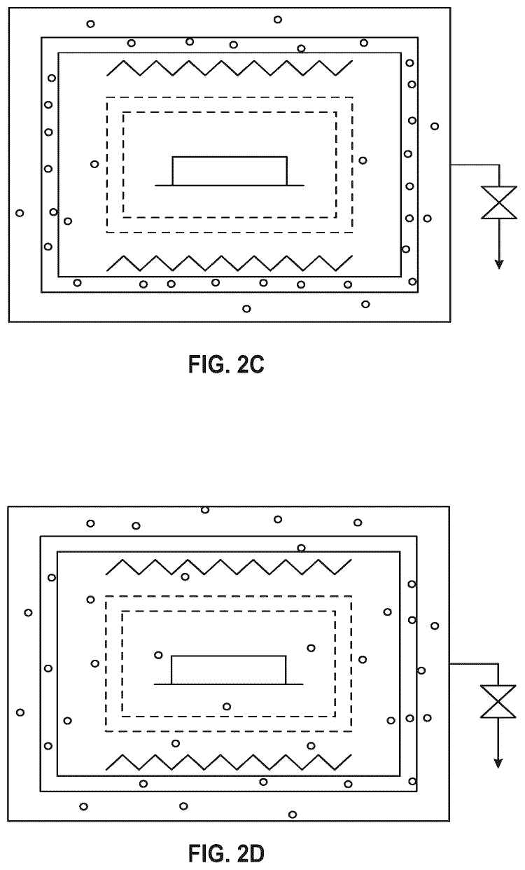

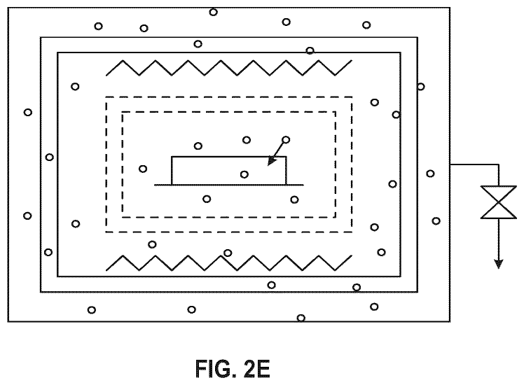

As shown in FIG. 2A, when an insulation pack 201 of a furnace 202 is exposed to the ambient room environment 203 (for example, when the furnace is opened to load or unload parts), the insulation pack 201 may adsorb a large amount of water and/or other reactive species 204. In one aspect, during the loading or unloading of parts 205, the insulation pack 201 may adsorb between approximately 10 g and approximately 200 g of water (FIG. 2B) depending on the ambient humidity level, the material, and the layout of the insulation. When the insulation pack 201 is heated up (FIG. 2C) with heaters 206, the adsorbed water may be desorbed slowly, which may provide a stream, e.g., a constant stream, of water vapor that may enter the hot zone (FIG. 2D). Here, the water may react with the hot graphite retort 207 to form CO and/or CO₂. Exposure to the CO and/or CO₂ may cause the graphite retort 207 to deteriorate over time, which may, in turn, necessitate an expensive replacement, repair downtime, etc. The reactive species 204 my also interact with the parts 205 (FIG. 2E).

The insulation pack 201 may also harbor condensed organic molecules (for example, oligomers that may result from pyrolysis of the polymer backbone present in printed parts as the parts are processed in the furnace). For example, organic binders can offgas from the parts during debinding while simultaneously absorbing into the outer (cooler) layers of insulation. As temperatures increase for sintering, those absorbed binders may offgas during later parts of the same overall cycle. Any remaining organic molecules still in the system at the completion of the cycle may become volatile on subsequent runs of the furnace and may provide a source of reactive species.

The reactive species may include, for example, H₂O, CO, CO₂, or organic molecules then migrate into the retort and react with the parts. The reactive species may have multiple effects. For example:
The oxygen-containing species may oxidize the metal, which may form a layer of oxide and impede sintering.
The H₂O and/or CO₂ may react with the carbon in the alloy, which may remove the carbon in the alloy as CO and/or CO₂.
Organic molecules may add carbon to the parts, which may be difficult to control and/or account for during the heating and/or sintering because the addition of carbon may be dependent on the furnace type, usage, size, etc.

Furthermore, because these reactions between the reactive species and the parts start at the surface and proceed inwards, part properties may vary from one region to the other. Users may expect the printed parts to have uniform properties across the part, and a chemistry that conforms to the specification for that material. These effects may cause the part to fall out of specification for the specific part.

Users may use a different type of insulation (e.g., graphite and metal hot zone furnaces use materials that do not adsorb near as much water). Alternatively, users may use a sealed retort that does not allow mixing of atmosphere from outside the retort with the inside. Moreover, users may use a tube furnace, which is limited in size. However, such practices often tend to be expensive upfront, for example, running thousands to tens of thousands of dollars more expensive than furnaces according to one or more embodiments discussed herein. Even a high performance furnace such as a graphite insulation furnace or a multilayer molybdenum furnace can still benefit from the introduction of getters in accordance with this disclosure. By doing so, one may yield yet higher quality parts, or a pathway to processing materials that are otherwise difficult to sinter.

Getters include sacrificial materials (or “getter materials”) that may be positioned in various positions within the vacuum chamber in order to preferentially react with the aforementioned reactive species and help to remove the reactive species from the environment. Accordingly, the getters may help to restore the inertness of the atmosphere and may help to allow successful sintering of a wider range of materials during the sintering of the part(s).

As mentioned above, in one aspect, the furnace system of the present disclosure is a vacuum sintering furnace. The furnace may be office-friendly, with one potential measure of office friendliness being reduced power relative to industry standards. Accordingly, the furnace may use a relatively high amount of insulation in order to maintain the exposed face at a relatively low, office-friendly temperature, thus exacerbating the problem of absorption and subsequent desorption of reactive species during processing. Inside the insulation, the furnace may include a retort, into which the parts of interest are placed. The retort may be a graphite retort, and the retort may be unsealed, pseudo-sealed (or partially sealed), or highly-sealed. This retort may help to isolate the atmosphere outside the retort from that inside. Nevertheless, the retort may include some deliberate and/or undeliberate paths of conductance between the retort and its surrounding atmosphere, including those engineered for preferred gas flow paths and the inherent porosity of the graphite itself, as shown in FIG. 1.

Moreover, the furnace may operate differently from many sintering furnaces. For large Metal Injection Molding (“MIM”) operations, large and expensive equipment (i.e., a metal hot zone furnace) may often be acceptable due to the high volume of parts that are processed, for example, in order to quickly account for such a high initial purchase. MIM may also be capable of using very large gas flows (including non-inert gases such as hydrogen) to bias the reaction kinetics, such that there is little opportunity for reactive species to interact with the parts being heated. However, for a smaller, office-friendly furnace, both the large initial cost and the large amount of gas flow may not be feasible. Instead, the furnace may have a smaller throughput and lower volume of parts than MIM or other furnaces. Moreover, the furnace may be less expensive (e.g., without a metal hot zone or equivalent “clean” and expensive furnace) and may use less processing gas.

In any of the aspects discussed herein, the getter material may include pure titanium, pure zirconium, one or more zirconium alloys, or any other material that may react with the reactive species. Moreover, the getter material may be in the form of a solid (e.g., sheets, pipes, etc.), a foil, turnings, a powder, a pulverized sponge or sponge grit, pills made by pressing any of the above morphologies into a condensed geometry, or any other appropriate form. The particle size and/or specific surface area of the getter material may be considered and/or varied by selecting an appropriate morphology of the getter material. For example, very finely divided Zirconium (e.g., tens of μm) may provide a very large pumping speed (rate at which the reactive species are removed from the atmosphere) as soon as the finely divided Zirconium is activated. However, the finely divided Zirconium may quickly saturate when exposed to various reactive species. Larger particles (e.g., hundreds of μm to a few mm) may have a lower peak pumping speed but may be able to sustain their pumping speed for a relatively longer duration. Different applications may work well with different combinations of these properties. Additionally, the morphologies and/or sizes may be varied and/or combined in order to obtain a specific pumping speed, duration, and/or other characteristics.

Moreover, the amount of getter material necessary for a specific application may depend on various characteristics. For example, as discussed below, the location (e.g., inside or outside of the retort, etc.) of the one or more getters may affect the necessary amount of getter material. The material and/or morphology may also affect the necessary amount of getter material. Furthermore, environmental factors, such as, for example, ambient humidity, ambient temperature, duration of exposure of furnace to the ambient environment, etc., may affect the necessary amount of getter material. The material(s) of the part(s) being processed and/or the amount or size of the part(s) being processed may also affect the necessary amount of getter material.

As shown in FIG. 1, getter material may be placed inside the hot zone but outside the retort, for example, above the retort, to form one or more getters. In this configuration, the one or more getters has a high conductance path to the atmosphere outside the retort, where the reactive species desorbing from the insulation may first appear. With the getter outside the retort and with a retort “hole” (representative of porosity) of much smaller surface area than the getter, the reactive species desorbing from the insulation would be more likely to impinge on the getter than to enter the retort to impinge on the parts. As an example, the getter outside the retort may “pump” the reactive species with greater pumping speed than the parts inside the retort. This may be the case even for highly absorptive parts if the retort conductance is small enough to choke off flow relative to the getter. Since the one or more getters are completely in the hot zone, the one or more getters are also heated to high temperatures along with the retort. This heating may help to activate the getter material (for example, by dissolving a surface oxide layer), and may also help the getter material to react with any reactive species present in the atmosphere. The getter material may react with and rapidly remove any reactive species present in the atmosphere. This reaction and removal may help to allow the furnace to sinter materials that are sensitive to these reactive species in a cost-effective manner. Additionally, including the one or more getters in the furnace may not require additional investment to obtain one of the other styles of furnaces described in the previous section or further modifications of the furnace. Accordingly, a user may be able to sinter materials that might otherwise not be possible to sinter with standard furnaces.

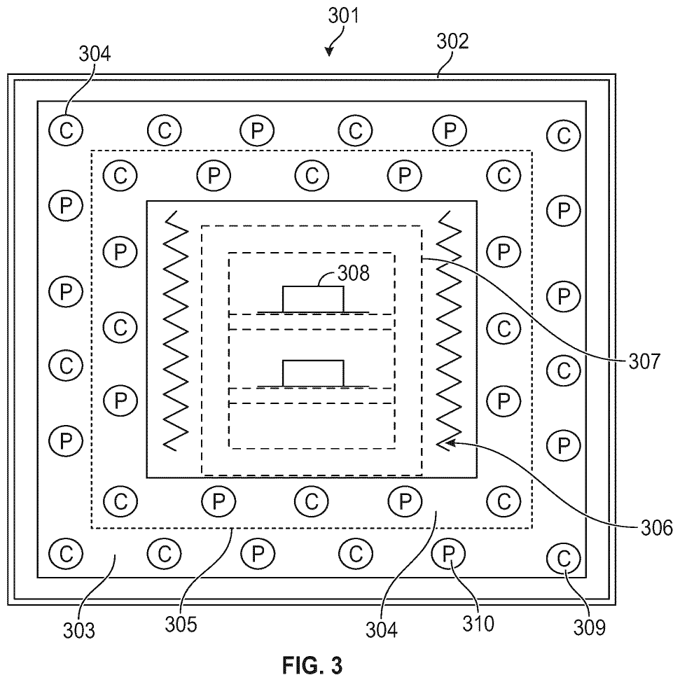

FIG. 3 depicts a furnace system 301 having a vacuum housing 302 surrounding an outer insulation panel 303 and inner insulation panel 304 with an interface layer 305 between them. Heaters 306 are configured to heat a hot zone at least partially containing a retort 307 containing parts 308. Chemisorbed water 309 and physiosorbed water 310 can be seen in the insulation layers.

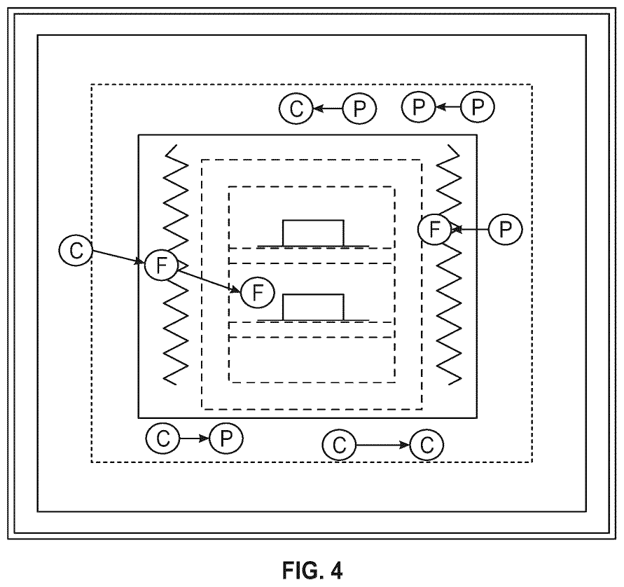

FIG. 4 depicts the furnace system of FIG. 3 wherein the molecular species can move from free water 311 to an absorbed state and can move between more tightly-bound (e.g., chemisorbed) and less tightly-bound (physiosorbed) states.

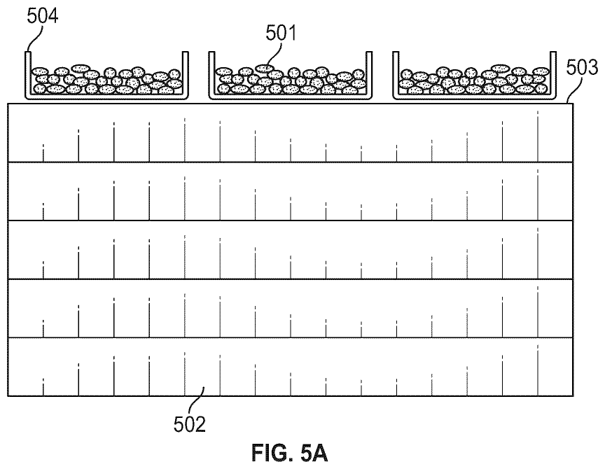

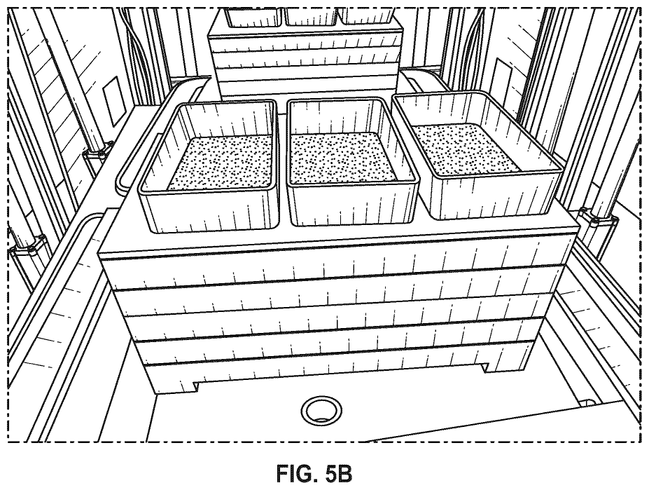

FIG. 5A illustrates the one or more getters 501 positioned within the furnace assembly, for example, outside of the retort 502 and/or supported by a top portion of the retort 503 within containers 504. FIG. 5B illustrates the one or more getters including the getter material (e.g., Zirconium sponge grit), for example, outside of the retort and/or supported by the top portion of the retort.

The getter material may be placed in various locations within the furnace. In one aspect, the getter material may be positioned within the retort. The retort may have a lower concentration of reactive species. For example, most reactive species are likely liberated into a gaseous phase or are generated outside of the retort (e.g., from the insulation). Additionally, new gas may be regularly, e.g., constantly, injected directly into the retort (FIG. 1), which may help to dilute the atmosphere and, thus, lower the concentration of reactive species within the retort. Nevertheless, with the getter material inside the retort, the getter material directly competes with the one or more parts positioned within the retort for the reactive species. In this configuration, the getter material may react with and remove reactive species at a rate that is much greater than the rate at which the reactive species are reacting with the one or more parts within the retort. Additionally, with the getter material within the retort, the getter material may be positioned such that the atmosphere between the part at the getter material is “well mixed,” meaning that the reactive species has a chance and/or probability to encounter and/or react with the getter material before the reactive species encounter and/or react with the part(s).

In another aspect, and as discussed above, the getter material may be positioned in the hot zone, for example, outside of the retort but within the high-temperature region of the furnace. In this configuration, the getter material may react with the reactive species before the reactive species enter the retort. Moreover, in this configuration, a greater amount of the reactive species may interact with the getter material. If the getter material has a high enough capacity, the getter material may lower the concentration of the reactive species in the entire furnace system. Moreover, since any impure gas that is leaking into the retort has a lower concentration of reactive species, the parts within the retort may interact with a purer atmosphere (with less reactive species).

In yet another aspect, the getter material may be positioned on or within the insulation or insulation pack. In this aspect, placing the getter material inside the insulation or insulation pack may position the getter material physically closer to the source of reactive species, which may help to remove the reactive species from the atmosphere before the reactive species reach the retort and/or the part(s) within the retort. Additionally, depending on the physical location of the getter material within the insulation or insulation pack, it may be possible to control when the getter material activates (e.g., is heated to a certain temperature). The activation temperature of the getter material may be correlated or otherwise correspond to a temperature at which the reactive species are emitted from the insulation or other components of the furnace.

In one aspect, the getter material may be positioned within the furnace chamber. The getter material may be placed in other positions inside the chamber, for example, in a position that forces any input gas to flow over and/or through the getter material. If the getter material is connected to an independent heater, the getter material may be activated independent of the hot zone temperature within the furnace. In one example, getter material may be used to filter inlet gas from outside of the retort (for example, in a similar manner as an air filter in an air conditioning unit or residential furnace).

Whether inside or outside the retort, in some embodiments it may be beneficial to arrange getters in some form of channel or complicated flow arrangement with a tortuous path such that undesirable contaminants and/or gases are forced to flow around the getters and react before impinging on the parts.

Various combinations of two or more of these configurations are also possible, and might result in performance that is better than any single configuration by itself.

The getter material may be supported by one or more components of the furnace. For example, one or more getters containing getter material may be held in place by a top plate of the retort, with the top plate of the retort holding the one or more getters within inside or outside of the retort (FIGS. 5A and 5B). Moreover, it is noted that the getter material may be positioned in any combination of the positions discussed herein. For example, the getter material may be positioned in two of more of the positions, and the positions may be selected based on the furnace configuration, material of the parts being treated, material of the insulation, etc.

As mentioned above, one approach to blocking parts from reactive species is to seal the retort either completely or partially. In cases where the retort is somewhat sealed but not perfectly sealed, the getter material may be used in combination with the sealed retort. The retort may be sealed very well, especially in comparison to commercial furnaces. In the context of this disclosure, a very well sealed but nevertheless imperfectly sealed retort can be thought of as having a smaller hole with a lower conductance, which in turn tends to increase the efficacy of the described approach.

The sealing of the retort provides a physical barrier between the inside of the retort and the area outside of the retort, and the physical barrier may help to reduce the amount of getter material that is necessary to improve the material properties of the part(s) being treated. In addition to the physical barrier formed by the sealed retort, the getter material may be combined with higher gas flow rates, with the flow rate acting as an isolation barrier to minimize the interaction between parts and reactive species. Nevertheless, these examples may not be necessary to yield the benefits of using the getter material discussed herein, and the aspects (size, morphology, location, etc. of the getter material) discussed herein may be used with other furnaces.

As mentioned above, the specific details of the getters and/or getter materials may be modified for specific heating, sintering, etc. applications. For example, the getter material, morphology, location, packaging, and other factors may be modified and/or selected according to the system requirements, such as a predetermined conductance between the source of reactive species, getters, parts, etc. Furthermore, practical factors or limitations may be considered as well. For example, it is dangerous to ship, store, or handle finely divided getter materials, as the finely divided getter materials may pose a fire hazard and/or a biohazard risk. Under certain conditions, it may be possible for the getter material to have a hybrid morphology. For example, the getter material may be a finely divided getter material that is compacted into pills, such that the pills pose less of a fire hazard or a biohazard risk than the finely divided getter materials, but still retain a surface area of finely divided particles. In some aspects, the above details may be considered through a predictive algorithm configured to determine one or more of amounts, types, morphologies, locations, etc., of the getter material to be used for a treatment cycle based on the size, number, material(s), etc., of the part(s) being processed during that treatment cycle.

As mentioned above, a box, or “retort,” may be positioned within the furnace. In addition to providing impedance to reactive gases and other outside contaminants, the retort may serve as a thermally conductive heat spreader to help to increase the thermal uniformity for observed for the parts being sintered. The retort may include one or more of the following features: a stackable assembly allowing for in-furnace assembly and/or adjustable heights, interlaced features on the seams to provide low through-wall conductance for gas flow out of or into the part zone, integrated gas distribution features, and/or high-contact shelf supports to improve thermal conductance into the part zone.

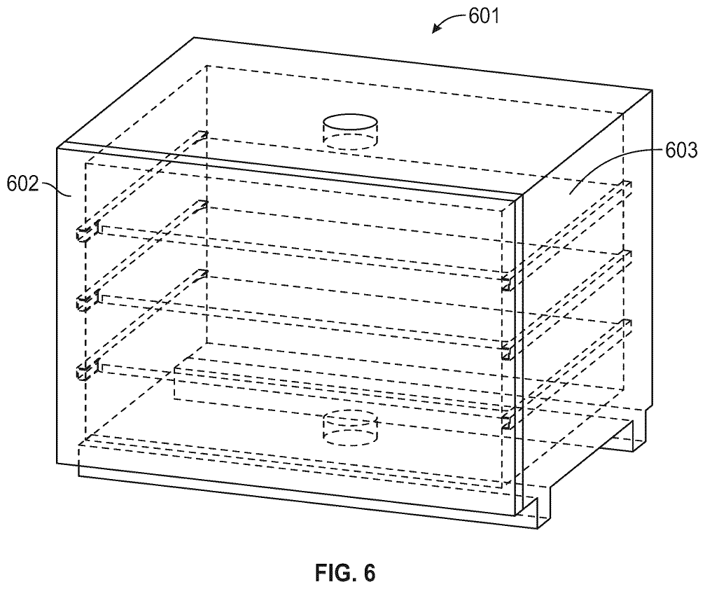

FIG. 6 depicts an embodiment retort 601 having a front opening 602 and a series of removable shelves 603 internally.

In order to obtain successful parts out of a Metal Injection Molded, Powder Metal, or 3D Printed sintering furnace, a few parameters may be of particular importance within the hot zone. These parameters may include one or more of: thermal uniformity, gas flow uniformity, gas flow velocity, pressure, and control of off-gassed products. The majority of these functions may be handled by a separate box within the hot zone, called a “retort.” As shown in FIG. 6A, these retorts may be five-sided boxes with integrated shelf supports and a separate front access door. Graphite is a common material used within Stainless Steel sintering, although other materials such as Stainless Steel and Molybdenum may be used for more difficult-to-sinter materials.

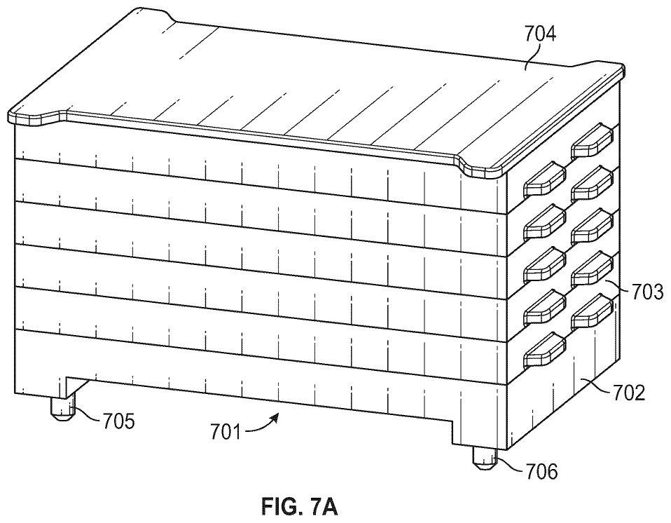

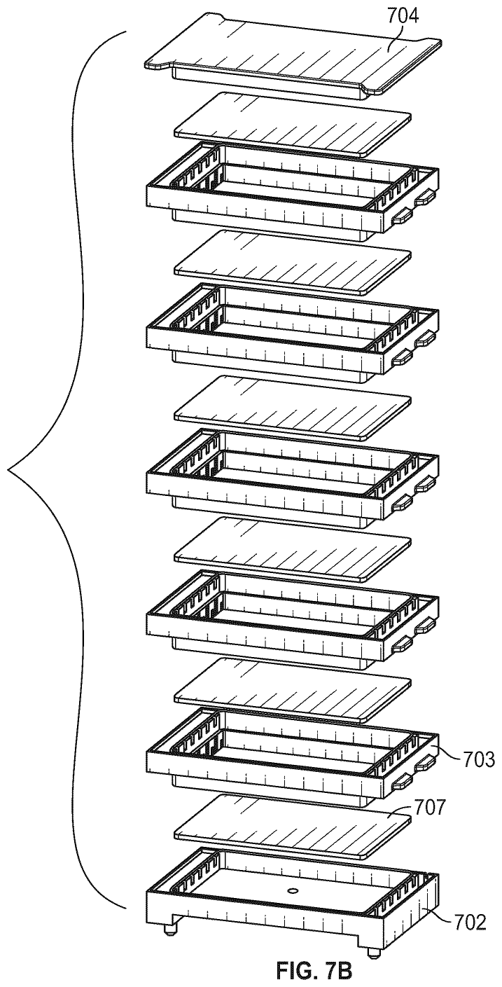

FIGS. 7A-B depicts an embodiment retort 701 for use in disclosed embodiments. With reference to FIG. 7A the retort is includes a base plate 702, a series of stacked retort components 703 and a top plate 704. The base plate incorporates a process gas inlet 705 and a effluent gas outlet 706. FIG. 7B depicts an exploded view of retort 701. Each of the series of stacked retort sections includes a removeable shelve 707.

While this design may be fairly simple to produce, it may have some usability limitations. Being immobile, accessing parts from the rear of a shelf may be difficult, especially for smaller parts positioned between two shelves. The volume within the box is usually fixed, which may make the internal cavity unnecessarily large for some parts. The retort itself also may block access from the rear of the furnace, which can make some access tasks, such as cleaning seals before starting a job, difficult. These features may limit the geometry of the overall furnace to a front-opening door style; placing the maintenance components in front of the retort to overcome the access concerns. Additionally, should a part have an issue within the retort which causes damage to the retort, such as a fracture or delamination, the entire retort often needs to be replaced. Finally, since sintering temperature-friendly sealing materials may be hard to come by, the front-access door typically has a poor seal resulting in the allowance for reactive agents outside of the retort to enter the retort and react with the parts being sintered.

The stacking retort components 703 create the walls of the box. By breaking the height of the wall into multiple rings, the user may be able to assemble or disassemble the retort 701 as needed. This may allow the user to access parts towards the rear of the furnace more easily by removing the stacked rings above the component of concern. It also may allow the user to remove the retort completely to access maintenance components previously blocked by an immobile retort, such as chamber seals, opening new freedoms in furnace geometry. The stacking design may allow the user to customize the height of the retort to fit their components, within the confines of the furnace itself; this may ultimately allow for gas savings during sintering by reducing gas usage for smaller runs of parts. Finally, by being comprised of multiple individual but identical rings, should a part have a sintering issue which damages one of these components, the damage may be contained to an individual component, which may allow for simpler and/or cheaper replacement.

The stacking rings may be designed in such a way that the seams are composed of a convoluted path such that there is no direct line of sight from the inside of the retort to the outside of the retort. Multiple jogs may create a low conductance path from the inside of the retort to the outside of the retort, which may help prevent the ingress of unclean gases and reactive agents from the outer sinter chamber into the part zone of the retort. These features may also create pockets for the optional part shelves which provide a high contact area for high thermal conductance from the external heaters into the part zone of the retort. This may help to provide a method of tightly controlling the thermal uniformity of the retort, which may help to improve part consistency and/or success.

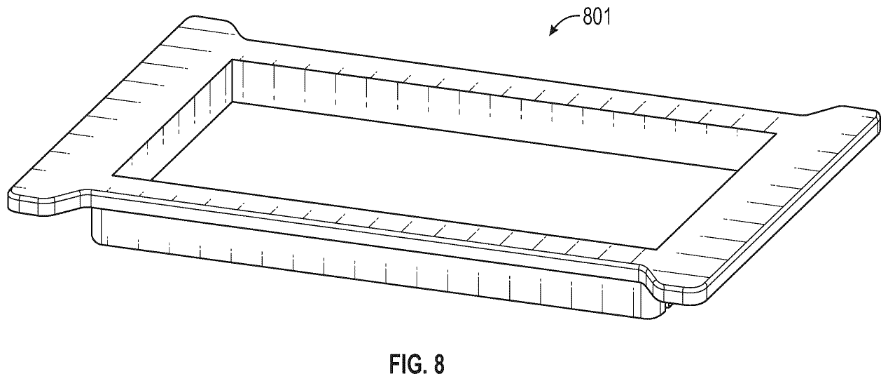

Additionally, as shown in FIG. 8, a retort top plate 801 may also be designed to include and/or support getters for use in trapping reactive agents.

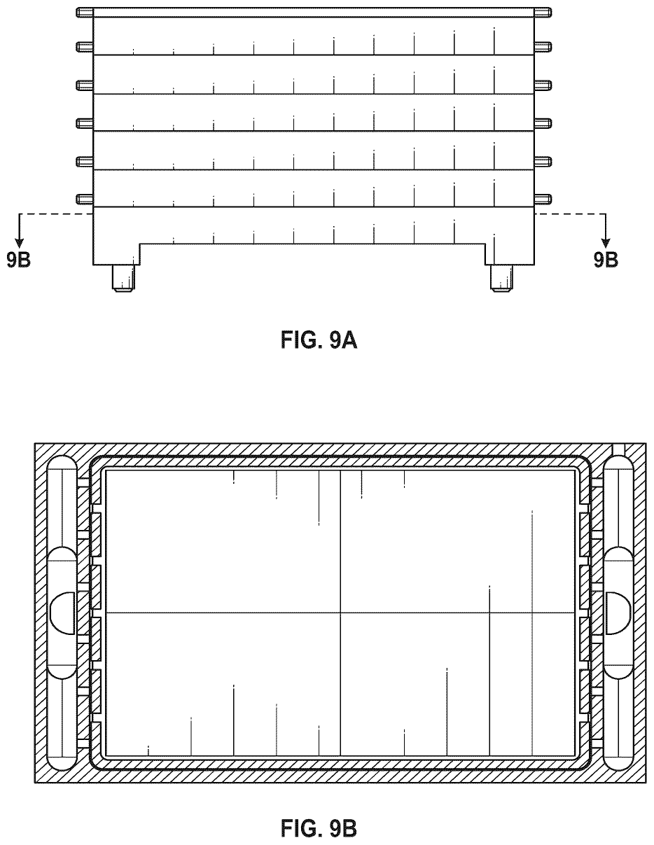

This retort design may be oriented for horizontal gas flow, as shown in FIG. 9, or vertical gas flow to align with different sintering furnace geometries. While currently described as produced in Graphite, alternative high-temperature materials may be used, such as various high temperature ceramics, including but not limited to Alumina and/or Silicon Carbide, various refractory metals including but not limited to Molybdenum, Tungsten, or various refractory grade Nickel alloys, or combinations thereof.

FIG. 9A depicts a front plan view of the embodiment retort shown in FIGS. 7A-B while FIG. 9B depicts a top plan cutaway view of the base plate detailing the flow path for process gas through the retort.

Other embodiments of the present disclosure will be apparent to those skilled in the art from consideration of the specification and practice of the embodiments disclosed herein. While certain features of the present disclosure are discussed within the context of exemplary systems, devices, and methods, the disclosure is not so limited and includes alternatives and variations of the examples herein according to the general principles disclosed. It is intended that the specification and examples be considered as exemplary only, with a true scope and spirit of the present disclosure being indicated by the following claims.

What is claimed is:

1. A retort configuration having reduced contamination, comprising:
a retort disposed within a furnace and configured to receive a inflow of process gas through a inlet; and
at least one getter configured to lessen the number of reactive species within the retort during a thermal processing cycle.

2. The retort configuration of claim 1 wherein the getter is disposed within the retort during the thermal processing cycle.

3. The retort configuration of claim 1 wherein the getter is disposed exterior to the retort during the thermal processing cycle.

4. The retort configuration of claim 3 wherein the getter is disposed on a top of the retort.

5. The retort configuration of claim 1 wherein the retort includes a bottom plate, a plurality of stacked retort components and a top plate.

6. The retort configuration of claim 4 wherein the top plate includes a recess for receiving the at least one getter.

7. The retort configuration of claim 1 wherein the retort is configured for horizontal flow of the process gas.

8. The retort configuration of claim 1 wherein the retort is configured for vertical flow of the process gas.

9. The retort configuration of claim 1 wherein the at least one getter is zirconium or a zirconium alloy.

10. The retort configuration of claim 9 wherein the at least one getter is a pulverized sponge or sponge grit.

11. A method of reducing contamination of parts during a thermal processing cycle, comprising:
disposing a retort containing a part to be processed and at least one getter within a furnace; and
providing a flow of process gas through the retort while conducting a thermal processing cycle, wherein the getter reacts with reactive agents in the furnace.

12. The method of claim 11 wherein the getter is disposed within the retort.

13. The method of claim 11 wherein the getter is disposed exterior to the retort.

14. The method of claim 11 wherein the getter is disposed on a top of the retort.

15. The method of claim 11 wherein the retort includes a bottom plate, a plurality of stacked retort components and a top plate.

16. The method of claim 15 wherein the top plate includes a recess for receiving the at least one getter.

17. The method of claim 11 wherein the process gas flow flows horizontally through the retort.

18. The method of claim 11 wherein the process gas flow flows vertically through the retort.

19. The method of claim 11 wherein the at least one getter is zirconium or a zirconium alloy.

20. The method of claim 19 wherein the at least one getter is a pulverized sponge or sponge grit.
